(19) United States
(12) Patent Application Publication
(10) Pub. No.: US 2016/0196613 A1
(43) Pub. Date: Jul. 7, 2016

(54) Automated Driver Training And Premium Discounts

(71) Applicant: STATE FARM MUTUAL AUTOMOBILE INSURANCE COMPANY, BLOOMINGTON, IL (US)

(72) Inventors: Melissa Miles, Mesa, AZ (US); John Nepomuceno, Bloomington, IL (US); Brian Fields, Normal, IL (US); Jenna Durako, Bloomington, IL (US); Jeremy Fogg, Bloomington, IL (US)

(73) Assignee: STATE FARM MUTUAL AUTOMOBILE INSURANCE COMPANY, BLOOMINGTON, IL (US)

(21) Appl. No.: 15/070,539

(22) Filed: Mar. 15, 2016

Related U.S. Application Data
(63) Continuation-in-part of application No. 13/172,240, filed on Jun. 29, 2011.

(51) Int. Cl. G06Q 40/08; G09B 19/16

(52) U.S. Cl. CPC G06Q 40/08; G09B 19/167

(57) ABSTRACT

A method may include providing a driver qualification application for installation on a mobile device; collecting driver data at an insurance company server; and transmitting the data through the driver qualification application to the server. The server may include a processor and a memory that stores the driver data. The server may select components of a driver qualification training plan to qualify the driver for one or more insurance ratings, based at least in part on the driver data. The server may generate a customized driver qualification training plan for the driver based on the selected components and store the training plan. The server may transmit the training plan using the driver qualification application. The server may receive notices from the driver qualification application indicating one or more components has been attempted and/or completed. When all components are complete, the server may generate an alert over a wireless communication channel to the mobile device. The alert may activate the driver qualification application to display a notification that the driver is qualified for the insurance rating.

### RELATED PATENT APPLICATION

This application is a continuation-in-part of U.S. application Ser. No. 13/172,240, filed Jun. 29, 2011, the contents of which are hereby incorporated by reference in their entirety.

### FIELD OF THE DISCLOSURE

This disclosure generally relates to providing insurance policies to customers and, more particularly, to qualifying a driver for a premium discount.

### BACKGROUND

An insurance company may wish to provide an incentive for certain behaviors or attract certain classes of policy holders. For example, automotive insurance companies may provide premium discounts to drivers based on various criteria and/or qualifications (e.g., a driver history without at-fault motor vehicle accidents or moving violations). As another example, an insurance company may provide a premium discount for drivers who complete certain training requirements such as a driver's education course. On the other hand, an insurance company may wish to provide the most competitive premium rates to the best qualified drivers in order to compete for their business.

In typical insurance premium calculation systems, an insurance company relies on its agent/representative to collect data related to potential premium discounts. Third party driver's education courses may provide driver training and/or certification of course completion. Once the driver is determined to be qualified, there is no ongoing requirement for qualification and/or ongoing training in most premium discount systems.

Collected data related to driving behavior shows that drivers are most at risk for driving accidents and/or risky driving behaviors during their first two years of driving. The lowest risk occurs when new drivers are accompanied by parents or driving instructors. An automotive insurance company would, therefore, wish to encourage new drivers to continue or extend the driving behavior exhibited while accompanied by parents and/or driving instructors throughout their first two years of driving. An example may include providing training and/or performance incentives in the form of premium discounts.

### SUMMARY

This summary is provided to introduce teachings of the present disclosure in a simplified form. The teachings are not limited to this summary, nor should the summary be read to limit the scope of the claimed subject matter.

In one embodiment, a method for qualifying a driver for an insurance rating may include providing a driver qualification application to a driver for installation on a mobile device; collecting driver data at an insurance company server; and transmitting the data through the driver qualification application to the server. The server may include a processor and a memory that stores the driver data. The server may select components of a driver qualification training plan to qualify the driver for one or more insurance ratings, the components selected at least in part based on the driver data. The server may also generate a customized driver qualification training plan for the driver based on the selected components and storing the training plan at the server. The server may transmit the training plan to the mobile device through the driver qualification application. The server may receive notices from the driver qualification application indicating one or more components has been attempted or completed. When all components are complete, the server may generate an alert over a wireless communication channel to the mobile device. The alert may activate the driver qualification application to display a notification that the driver is qualified for the insurance rating.

In another embodiment a method for offering vehicle insurance to a driver may include receiving a request sent over the internet from a mobile device initiated by a user for one or more vehicle insurance policies for a driver; providing the user access to download an application to the mobile device over a wireless communication channel; receiving driver information sent from the mobile device over the wireless communication channel triggered by the application to an insurance company server; receiving at the server driver performance data collected by sensors in communication with the mobile device during one or more trips made in a vehicle; calculating, by the processor, a driver performance score based at least in part on the driver performance data transmitted by the mobile device; and determining whether to qualify the driver for the one or more requested vehicle insurance policies based on the driver performance score. The driver information may be collected by operation of the application and transmitted to the insurance company server by the mobile device. The server may comprise a processor and a memory that stores the driver information. The driver performance data may reflect driving behaviors of the driver during the one or more trips.

Another embodiment may include a non-transitory computer readable medium with computer executable instructions stored thereon executed by a processor to perform a method of qualifying for a premium discount. The method may include collecting driver information associated with a driver through a mobile device interface; sending the collected driver information to an insurance company server from the mobile device over the Internet; receiving a customized driver qualification training plan to qualify the driver for one or more insurance ratings; noting when the driver attempts a component of the training plan; monitoring driving behavior of the driver during execution of the component of the training plan; generating a notice indicating one or more components has been attempted or completed; transmitting the notice to the insurance company server over the Internet; and when all components are complete, indicating to the driver the customized driver qualification plan has been completed. Particular components of the training plan may be determined by the insurance company server at least in part based on the driver information.

### BRIEF DESCRIPTION OF THE DRAWINGS

FIG. 1 is a drawing illustrating an example mobile device located in a vehicle according to teachings of the present disclosure.

FIG. 2 is a drawing illustrating an example system for sharing driving data between a mobile device and other external systems or devices according to teachings of the present disclosure.

FIG. 3 is a drawing illustrating example components of a mobile device which may implement some of the teachings of the present disclosure.

FIG. 4 is a flowchart illustrating an example method implementing various aspects of the present disclosure.

FIGS. 5A-5E are drawings showing example screenshots that might be generated by an application for display on a user's mobile device, according to teachings of the present disclosure.

FIG. 6 is a flowchart illustrating an example method for offering vehicle insurance to a driver according to teachings of the present disclosure.

FIG. 7 is a flowchart illustrating an example method which may be used by a driver or other user to request an insurance rating and/or an associated premium discount according to teachings of the present disclosure.

The figures provide illustrations of various embodiments of the teachings of the present disclosure. A person having ordinary skill in the art will be able to use the teachings of the present disclosure to develop alternative embodiments of the structures and methods depicted in the figures without departing from the scope of the claims or the teachings of the present disclosure.

### DETAILED DESCRIPTION

Various efforts and programs have been initiated to improve driving safety over the years. For example, driving instruction courses (often referred to as “drivers ed”) are intended to teach new drivers not only how to drive, but how to drive safely. Typically, an instructor rides as a passenger and provides instruction to the learning driver, and evaluates the driver's performance. As another example, “defensive driving” strategies aim to reduce the driving risks by anticipating dangerous situations, despite adverse conditions or the mistakes of others. This can be achieved through a variety of general rules, as well as the practice of specific driving techniques. Driving courses may provide a variety of benefits. For example, in many states, completing a defensive driving course may suffice to dismiss traffic tickets or to qualify the driver for a discount on car insurance premiums.

From the perspective of an automobile insurance provider, the provider seeks to assess the risk level associated with a driver and price an insurance policy to protect against that risk. The process of determining the proper cost of an insurance policy, based on the assessed risk level, is often referred to as “rating.” The rating process may include a number of input variables, including experience data for the specific driver, experience data for a class of drivers, capital investment predictions, profit margin targets, and a wide variety of other data useful for predicting the occurrence of accidents as well as the amount of damage likely to result from such accidents.

The teachings of the present disclosure may be employed to reduce the risk incurred by a driver. In some embodiments, this may include providing a course of training for the driver. The insurance company may provide an incentive for the driver by offering a premium discount for drivers who complete the course. In some examples, the course may be particularly appropriate for a novice driver. In contrast to typical systems for providing premium discounts, however, the teachings of the present disclosure may provide systems and methods for automatically generating customized courses of training based on various driver information, including but not limited to experience level, vehicle type, current automotive insurance policy, etc.

In some embodiments, the driver training course may include various training modules. The training modules may include training drives, recorded video, audio, and/or text material, and/or additional content and/or activity for the driver. The systems and methods may track completion of the training modules to confirm completion of the course in part or in whole. In addition, some embodiments may include monitoring and/or measuring various driver performance metrics while completing training drives, scoring written examinations, and/or alternative scoring metrics.

Once complete, an insurance company may provide a premium rate adjustment based at least in part on completion of the training course. In some embodiments, various premium adjustments may be available based on driver performance metrics as well as completion of tasks and/or course modules. In some embodiments, the systems and methods disclosed herein may be used to qualify for Graduated Driver's License requirements as provided by a licensing authority.

Embodiments of the present disclosure and their advantages over the prior art may be best understood by reference to the Figures described below.

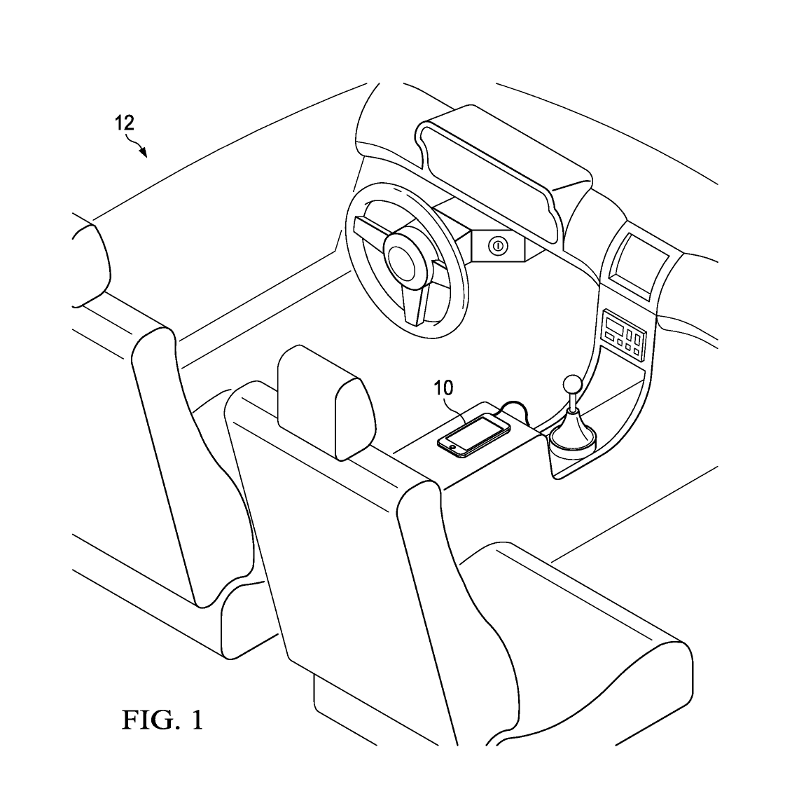

FIG. 1 is a drawing illustrating an example mobile device 10 located in a vehicle 12, according to certain embodiments or implementations of the present disclosure. Mobile device 10 may comprise any type of portable or mobile electronics device, such as for example a mobile telephone, personal digital assistant (PDA), laptop computer, tablet-style computer such as the iPad by Apple Inc., or any other portable electronics device. For example, in some embodiments, mobile device 10 may be a smart phone, such as an iPhone by Apple Inc., a Blackberry phone by RIM, a Palm phone, or a phone using an Android, Microsoft, or Symbian operating system (OS), for example.

Mobile device 10 may include one or more components providing wireless connection to the Internet and/or other wireless communications. In some embodiments, mobile device 10 may be configured to provide one or more features of a driving analysis system provided by an insurance company, such as (a) collection of driving data (e.g., data regarding driving behavior and/or the respective driving environment), (b) processing of collected driving data, and/or (c) providing feedback based on the processed driving data. Accordingly, mobile device 10 may include one or more sensors, a driving analysis application, and a display.

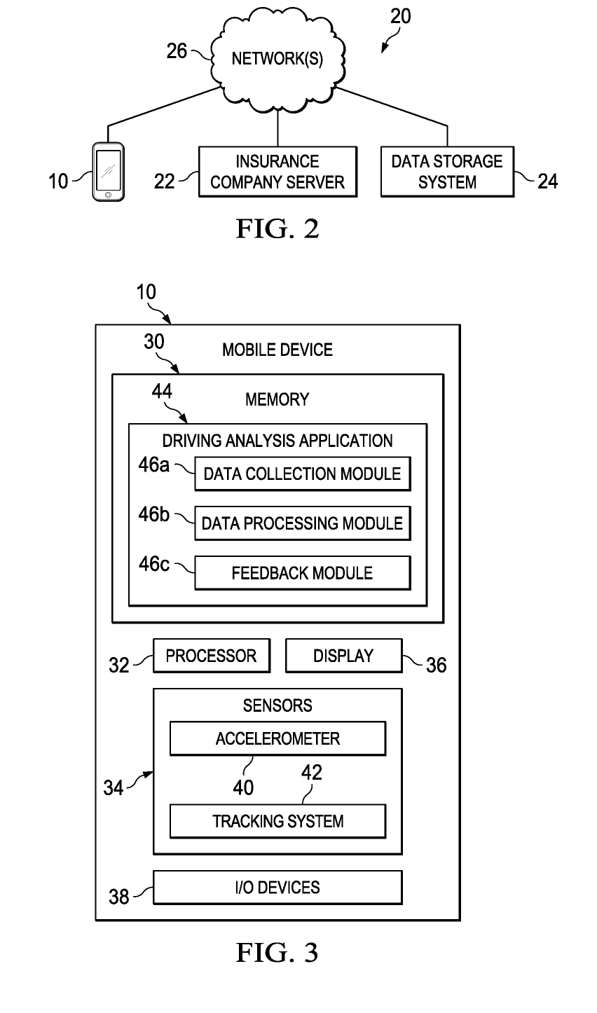

FIG. 2 is a drawing illustrating an example system 20 for sharing driving data between a mobile device 10 and other external systems or devices, according to certain embodiments. As shown, mobile device 10 may be communicatively connected to one or more remote servers 22 and/or remote data storage systems 24 via one or more networks 26.

Servers 22 may include any one or more devices operable to receive driving data from mobile device 10 and further process and/or display such data, e.g., mobile telephones, personal digital assistants (PDA), laptop computers, desktop computers, or any other device. In some embodiments, a server 22 may include any suitable application(s) for interfacing with mobile device 10, e.g., providing application(s) to be downloaded via the Internet or otherwise installed on mobile device 10.

Remote data storage devices 24 may include any one or more data storage devices for storing driving data received from mobile device 10 and/or servers 22. Remote data storage 24 may comprise any one or more devices suitable for storing electronic data, e.g., RAM, DRAM, ROM, flash memory, and/or any other type of volatile or non-volatile memory or storage device. A remote data storage device 24 may include any suitable application(s) for interfacing with mobile device 10 and/or with relevant applications running on servers 22.

Network(s) 26 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data) via any one or more wired and/or wireless communication links.

In some embodiments, mobile device 10 may be used to request a discounted premium for an automobile insurance policy. For example, a user may engage mobile device 10 to access an insurance company's website, to send an email request, and/or any other appropriate means of communicating with an insurance company. When an insurance company receives a request for a discounted premium, servers 22 may communicate various options back to the user through mobile device 10, such as driver training courses that would qualify the driver for a discounted premium and/or other alternative qualifications.

FIG. 3 is a drawing illustrating example components of mobile device 10 for use with the teachings of the present disclosure. As shown, mobile device 10 may include a memory 30, processor 32, one or more sensors 34, a display 36, and input/output devices 38.

Memory 30 may store various applications to run or executed by processor 32. Memory 30 may comprise any one or more devices suitable for storing electronic data, e.g., RAM, DRAM, ROM, internal flash memory, external flash memory cards (e.g., Multi Media Card (MMC), Reduced-Size MMC (RS-MMC), Secure Digital (SD), MiniSD, MicroSD, Compact Flash, Ultra Compact Flash, Sony Memory Stick, etc.), SIM memory, and/or any other type of volatile or non-volatile memory or storage device.

Memory 30 may store various applications 44 which, when executed, direct the actions of processor 32. An application 44 may be described in terms of functional modules 46, each embodied in a set of logic instructions (e.g., software code). For example, as shown in FIG. 3, application 44 may include a data collection module 46a, a data processing module 46b, and a feedback module 46c.

Processor 32 may include a microprocessor, a microcontroller, a digital signal processor (DSP), an application specific integrated controller (ASIC), electrically-programmable read-only memory (EPROM), or a field-programmable gate array (FPGA), or any other suitable processor(s), and may be generally operable to execute various applications, as well as supporting any other functions of mobile device 10.

Sensors 34 may include any one or more devices for detecting information regarding a driver's driving behavior and/or the driving environment. For example, sensors 34 may include an accelerometer 40 configured to detect acceleration of the mobile device 10 (and thus, the acceleration of a vehicle 12 in which mobile device 10 is located) in one or more directions (e.g., the x, y, and z directions). As another example, mobile device 10 may include a location tracking system 42, such as a GPS tracking system or any other system or device for tracking the geographic location of the mobile device. A solid state compass, with two or three magnetic field sensors, may provide data to a microprocessor to calculate direction using trigonometry. The mobile device 10 may also include proximity sensors, a camera or ambient light.

Display 36 may comprise any type of display device for displaying information related to a user, such as for example, an LCD screen (e.g., thin film transistor (TFT) LCD or super twisted nematic (STN) LCD), an organic light-emitting diode (OLED) display, or any other suitable type of display. In some embodiments, display 36 may be an interactive display (e.g., a touch screen) that allows a user to interact with applications running on processor 32. In other embodiments, display 36 may be strictly a display device, such that all user input is received via other input/output devices 38.

Input/output devices 38 may include any suitable interfaces allowing a user to interact with mobile device 10, and in particular. For example, input/output devices 38 may include a touchscreen, physical buttons, sliders, switches, data ports, keyboard, mouse, voice activated interfaces, or any other suitable devices.

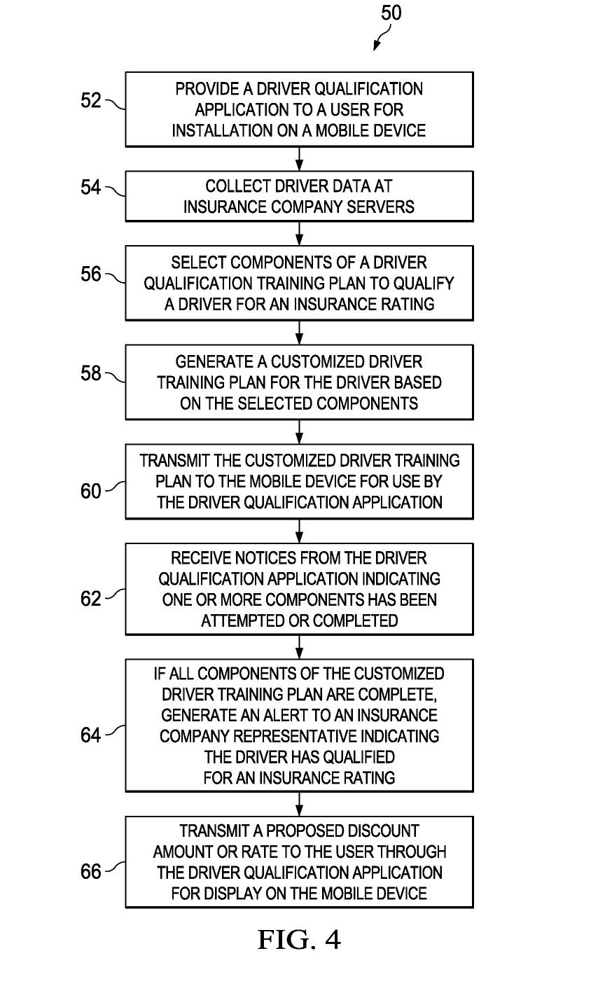

FIG. 4 is a flowchart illustrating an example method 50 implementing various aspects of the present disclosure. An insurance company may use method 50 to qualify a driver for an insurance rating.

Step 52 may include providing a driver qualification application to a user for installation on mobile device 10. A user may make a request to an automotive insurance company for an improved rating and/or a reduced premium amount. Step 52 may be initiated in response to such a request from a user. As used herein, the term “user” refers to the driver or other person operating mobile device 10.

Driver qualification application 44 may be embodied in any combination of software, firmware, and/or any other type of computer-readable instructions. Driver qualification application 44 and/or any related, required, or useful applications, plug-ins, readers, viewers, updates, patches, or other code for executing application 44 may be provided to the user for download via the Internet or installed on mobile device 10 in any other known manner. Once downloaded to mobile device 10, driver qualification application 44 may be stored in memory 30. Driver qualification application 44 may be described in terms of functional modules 46, each embodied in a set of logic instructions (e.g., software code). For example, as shown in FIG. 3, driver qualification application 44 may include a data collection module 46a, a data processing module 46b, and a feedback module 46c.

Step 54 may include collecting driver data at insurance company servers 22. The driver data may be collected by data collection module 46a running on mobile device 10. Driver qualification application 44 may transmit the collected driver data to insurance company servers 22 over the Internet or any other appropriate means for communicating data to the servers 22, for example, using feedback module 46c to communicate with servers 22 over the Internet.

In some embodiments, data collection module 46a may provide a form to be filled out by the user. In some embodiments, data collection module 46a may prompt the user to refer to an existing insurance policy and grant permission to the insurance company to access the existing policy to gather driver data. Driver data may include the age and/or the experience level of the driver, the primary vehicle to be driven, residence address, closest urban area, and/or any other information related to the identity, qualifications, and/or driving conditions of the driver.

Step 56 may include selecting components of a driver qualification training plan to qualify the driver for one or more insurance ratings. The components may be selected based at least in part on the driver data collected at Step 54. Insurance company servers 22 may execute software and/or firmware to analyze the driver data and identify components specifically targeted at the driver. In some embodiments, the selected components may include monitored training drives, video course content, accumulated driving time, and/or any other components designed to give additional experience to the driver, teach the driver defensive driving techniques, etc.

Step 58 may include generating a customized driver training plan for the driver based on the selected components and storing the customized plan at memory 20. In some embodiments, the customized driver training plan may include gradually more difficult content and/or training drives.

Step 60 may include transmitting the customized driver training plan to mobile device 10 for use by driver qualification application 44. The driver qualification application may provide a graphic user interface (GUI) for the user through feedback module 46c. Feedback module 46c may display the customized driver training plan generated by the insurance company servers 22 and allow the user and/or driver to learn how to qualify for the requested premium discount. In addition, feedback module 46c may allow the user and/or driver to record an attempt or completion of one or more of the components of his or her driver qualification training plan.

Step 62 may include receiving notices from the driver qualification application indicating one or more components has been attempted or completed. Insurance company servers 22 may receive these notices from mobile device 10 running driver qualification application 44. Servers 22 may record the progress of the driver through his or her customized driver training plan. In some embodiments, servers 22 may impose a limit on the number of failed attempts or a time limit for completion of all components of the training plan. In such embodiments, a driver may fail to qualify if he or she exceeds one of the various limits.

At Step 64, if servers 22 receive notices that all components of the customized driver training plan are complete, server 22 may generate an alert to an insurance company representative indicating the driver has qualified for an insurance rating. In some embodiments, this may include notifying an existing agent responsible for an existing automotive policy covering the driver. In other embodiments, Step 64 may include alerting an insurance agent that the driver has qualified for a discount to a policy and should be contacted to offer a new automotive policy. In some embodiments, the alert may include an actual discount amount or rate calculated by the servers 22.

Step 66 may include transmitting a proposed discount amount or rate to the user through driver qualification application 44 for display on mobile device 10. In some embodiments, step 66 may include confirming the insurance company has recorded the driver's completion of the customized driver training plan.

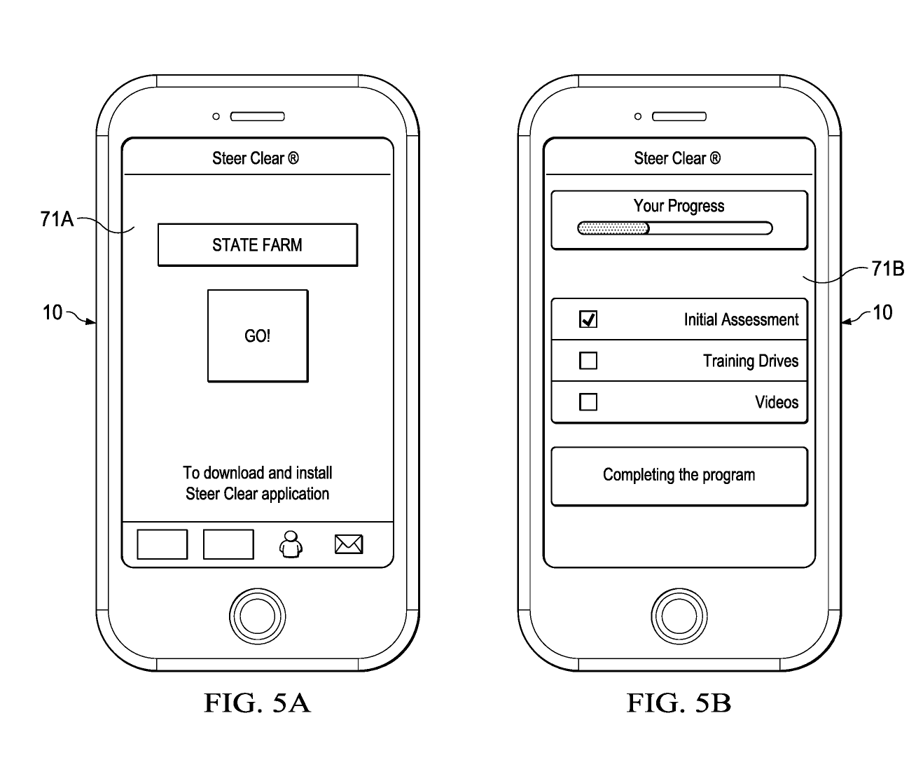

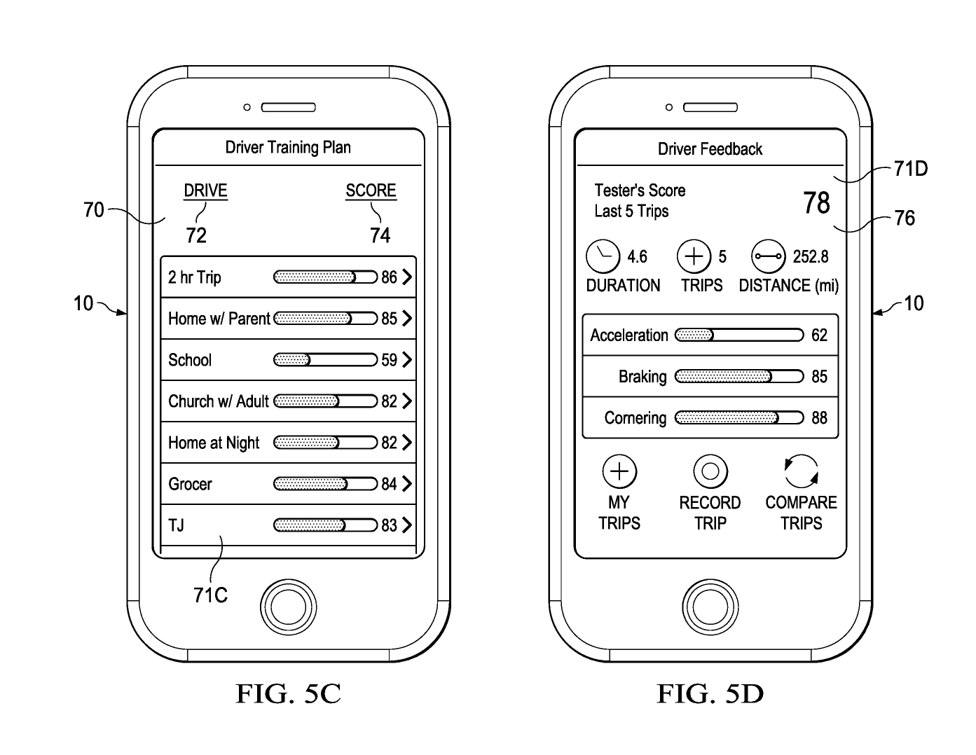

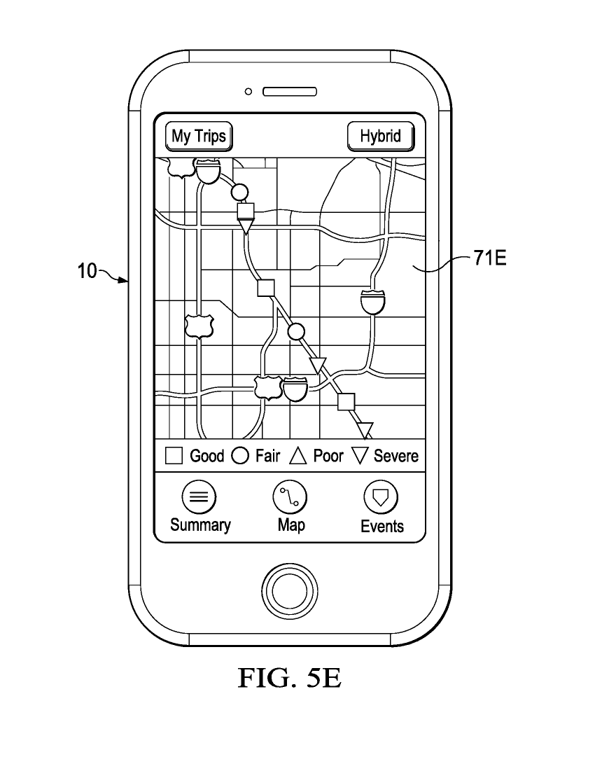

FIGS. 5A-5E are drawings showing example screenshots that might be generated by driver qualification application 44 for display on mobile device 10, according to teachings of the present disclosure.

FIG. 5A shows an example screenshot 71A that may be displayed to a user requesting entry into a driver training program. For example, the user may wish to be qualified for one or more improved insurance ratings, a reduced insurance premium, and/or request a new policy quote from an insurance company. The insurance company may provide wireless access to the user so that he or she may download driver qualification application 44 onto mobile device 10.

FIG. 5B shows an example screenshot 71B that may be displayed to a user participating in the driver training program. As shown in this example, the driver may have already completed entry of driver information. Further, screenshot 71B shows that one or more training drives and videos may be required before the driver has completed customized driver training plan 70. As previously noted, customized driver training plan 70 may include specific training drives 72 for the driver. As discussed above, novice drivers tend to exhibit the safest driving behaviors when accompanied by a parent or other adult trainer and the riskiest driving behaviors during their first two years of driving experience when no adult is present in the vehicle. Specific training drive requirements may include accompanied drives and/or solo drives. Required trips may include drives at various times of day (e.g., rush hour, in darkness, during active school zone hours, etc.). Required trips may include various road types (e.g., interstate and/or freeway drives, neighborhood drives, one-way roads, 4-lane roads, etc.). FIG. 5C shows an example screenshot 71C that may be used by driver qualification application 44 to display the training drives 72 for customized driver training plan 70. Screenshot 71C may display a completed/required status and/or various performance metrics.

In some embodiments, customized driver training plan 70 may include minimum performance scores 74 on specific required drives 72. In such embodiments, driver qualification application 44 may be operable to manage the collection of driving data, including driving behavior data and/or driving environment data. Data collection module 44a may collect such data from any number and types of data sources, including (a) data sources provided by mobile device 10 (e.g., sensors 34), (b) data sources in vehicle 12 but external to mobile device 10 (e.g., on-board vehicle computer, seat belt sensors, GPS system, etc.), and/or (c) data sources external to vehicle 12 (e.g., data sources accessible to mobile device 10 by a satellite network or other telecommunication links).

In certain embodiments, the mobile device 10 may communicate with a data source in vehicle 12 but external to mobile device 10 via a hardwire connection, Bluetooth® or other wireless means, optical signal transmission, or any other known manner. Sources in vehicle 12 but extended to mobile device 10 may include: engine RPM, speedometer, fuel usage rate, exhaust components or other combination indications, suspension system monitors, seat belt use indicators, tracking systems for other vehicles in vicinity, blind spot indicators.

Data collection module 44a may collect data over the course of a training drive corresponding to one component of the customized driver qualification plan 70. As used herein, a “training drive” 72 may refer to any period of driving, which may comprise a single uninterrupted trip, a portion of a trip, or a series of multiple distinct trips. A “data collection session” may generally correspond to one training drive, a portion of a training drive, or multiple distinct training drives. Any or all data collected by data collection module 44a may be time stamped (e.g., time and date), either by data collection module 44a itself or by another device that collected or processed particular data before sending the data to data collection module 44a. The time stamping may allow for data from different sources (e.g., data from accelerometer 34a, location tracking system 34b, a seat belt sensor, etc.) to be synchronized for analyzing the different data together as a whole). In some embodiments, data collection module 44a may collect data corresponding to physical parameters or characteristics of the car.

Data processing module 44b may be operable to process or analyze any of the driving data (e.g., driving behavior data and/or the driving environment data) collected by mobile device 10 itself and/or collected by external devices and communicated to mobile device 10, and based on such collected driving data, calculate one or more driving behavior metrics and/or scores. For example, data processing module 44b may calculate the driving behavior metrics of acceleration, braking, and/or cornering metrics based on driving behavior data collected by an accelerometer 34a, location tracking system 34b, and/or other collected data.

Further, data processing module 44b may calculate one or more driving scores based on the calculated driving behavior metrics (e.g., acceleration, braking, cornering, etc.) and/or based on additional collected data, e.g., driving environment data. As shown in FIG. 5B, driver qualification application 44 may use format 76 to display a score for a particular drive or for a combination of drives on mobile device 10. In some examples, the display may show elements of the score that were measured. For example, data processing module 44b may apply algorithms that calculate a driving score based on weighted values for each respective driving behavior metric, and environmental correction values based on the relevant driving environment data, such as weather, traffic conditions, road conditions, etc.

As another example, data processing module 44b may identify “notable driving events,” such as instances of notable acceleration, braking, and/or cornering, as well as the severity of such events. In some embodiments, data processing module 44b may account for environmental factors, based on collected driving environment data corresponding to the analyzed driving session(s). For example, the identification of notable driving events may depend in part on environmental conditions such as the weather, traffic conditions, road conditions, etc. Thus, for instance, a particular level of braking may be identified as a notable driving event in the rain, but not in dry conditions.

The customized driver qualification plan may include minimum required performance levels for certain components. For example, a particular training drive may not only be required, but may be considered failed unless the calculated driver performance score is above 75. In some embodiments, the customized driver qualification plan may limit the allowed number of notable driving events during any training drive or combination of drives. In some embodiments, the insurance company may access driving behavior data collected/processed by mobile device 10 and use such data to determine appropriate insurance products or premiums for the driver according to such risk analysis (e.g., performing rating functions based on the driving behavior data collected/processed by mobile device 10).

Driver qualification application 44 may store, display, and/or communicate driving behavior metrics and/or driving scores. FIG. 5D shows an exemplary screenshot 71D which may be displayed by driver qualification application 44 to show a driver performance score to the driver. Screenshot 71D may list the completed training drives 72 and an associated performance score 74 for each training drive 72.

In embodiments in which mobile device 10 includes a GPS or other geographic location tracking device, the application may also display a map 78 showing the route of a trip, and indicating the location of each notable driving event. FIG. 5E shows an example screenshot 71E for display by driver qualification application 44 with an example map 78 of a training drive 72.

Driver qualification application 44 may display some or all of such data on the mobile device 10 itself. In addition or alternatively, driver qualification application 44 may communicate some or all of such data via a network or other communication link for display by one or more other computer devices (e.g., smart phones, personal computers, etc.). Thus, for example, a parent or driving instructor may monitor the driving behavior of a teen or student driver without having to access the mobile device 10. The application may also display tips to help drivers improve their driving behavior.

In some embodiments, insurance company servers 22 may perform some or all of the data processing discussed above with respect to data processing module 44b on mobile device 10. For example, mobile device 10 may communicate some or all data collected by data collection module 44a (raw data, filtered data, or otherwise partially processed data) to servers 22, which may process (or further process) the received data, e.g., by performing any or all of the driver data processing discussed above with respect to data processing module 44a, and/or additional data processing. After processing the data, servers 22 may then communicate the processed data back to mobile device 10 (e.g., for storage and/or display), to other remote computers (e.g., for storage and/or display), and/or to remote data storage 24. The data processing and communication of data by servers 22 may be performed in real time or at any other suitable time. In some embodiments, servers 22 may process driving data from mobile device 10 and communicate the processed data back to mobile device 10 such that the data may be displayed by mobile device 10 substantially in real time, or alternatively at or shortly after (e.g., within seconds of) the completion of a training drive.

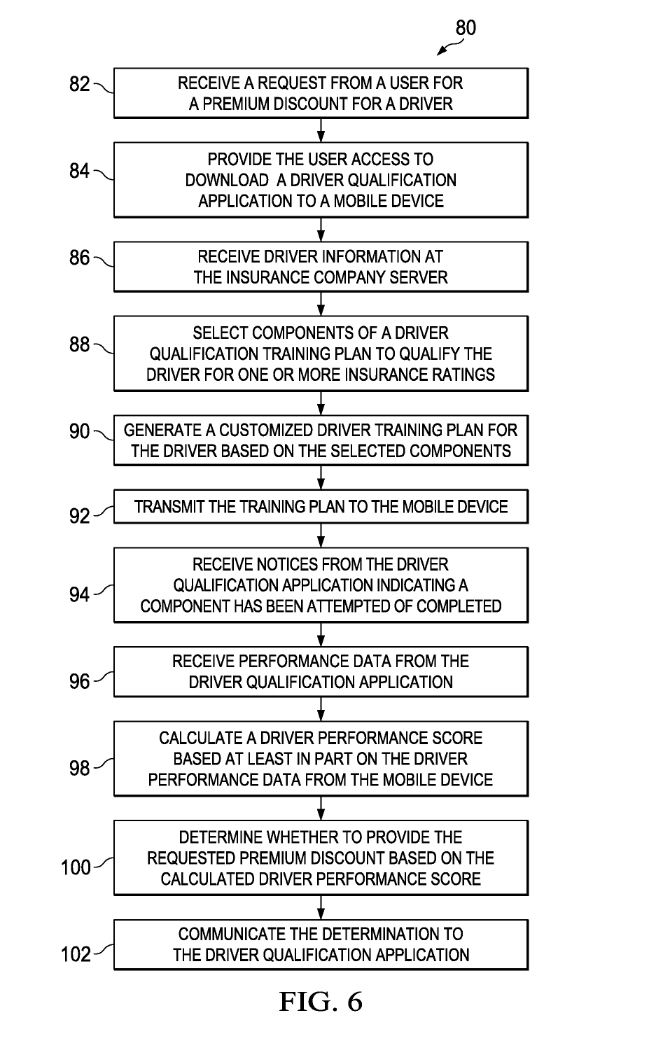

FIG. 6 is a flowchart illustrating an example method 80 for offering vehicle insurance to a driver. Method 80 may be executed by an insurance company server 22.

Step 82 may include receiving a request from a user for one or more premium discounts for a driver. The request may be received by the server 22 over the internet or any other appropriate means of communication. The user may initiate the request from his or her mobile device 10.

Step 84 may include providing the user access to download a driver qualification application 44 to mobile device 10. The application may be available over the internet and/or by other avenues of communication.

Step 86 may include receiving driver information at the insurance company server 22. The driver information may be collected by one or more modules of the driver qualification application 44. For example, the driver information may be collected by data collection module 46a running on mobile device 10. Driver qualification application 44 may transmit the collected driver data to insurance company servers 22 over the Internet or any other appropriate means for communicating data to the servers 22, for example, using feedback module 46c to communicate with servers 22 over the Internet.

In some embodiments, data collection module 46a may provide a form to be filled out by the user. In some embodiments, data collection module 46a may prompt the user to refer to an existing insurance policy and grant permission to the insurance company to access the existing policy to gather driver data. Driver data may include the age and/or the experience level of the driver, the primary vehicle to be driven, residence address, closest urban area, and/or any other information related to the identity, qualifications, and/or driving conditions of the driver.

Step 88 may include selecting components of a driver qualification training plan to qualify the driver for one or more insurance ratings. The components may be selected based at least in part on the driver data collected at Step 86. Insurance company servers 22 may execute software and/or firmware to analyze the driver data and identify components specifically targeted at the driver. In some embodiments, the selected components may include monitored training drives, video course content, accumulated driving time, and/or any other components designed to give additional experience to the driver, teach the driver defensive driving techniques, etc.

Step 90 may include generating a customized driver training plan for the driver based on the selected components and storing the customized plan at memory 20. In some embodiments, the customized driver training plan may include gradually more difficult content and/or training drives.

Step 92 may include transmitting the customized driver training plan to mobile device 10 for use by driver qualification application 44. The driver qualification application may provide a graphic user interface (GUI) for the user through feedback module 46c. Feedback module 46c may display the customized driver training plan generated by the insurance company servers 22 and allow the user and/or driver to learn how to qualify for the requested premium discount. In addition, feedback module 46c may allow the user and/or driver to record an attempt or completion of one or more of the components of his or her driver qualification training plan.

Step 94 may include receiving notices from the driver qualification application indicating one or more components has been attempted or completed. Insurance company servers 22 may receive these notices from mobile device 10 running driver qualification application 44. Servers 22 may record the progress of the driver through his or her customized driver training plan. In some embodiments, servers 22 may impose a limit on the number of failed attempts or a time limit for completion of all components of the training plan. In such embodiments, a driver may fail to qualify if he or she exceeds one of the various limits.

Step 96 may include receiving performance data from driver qualification application 44. For example, the performance data may include may include data collected by sensors in communication with mobile device 10 during one or more trips made in vehicle 12. The driver performance data may reflect driving behaviors of the driver during the one or more trips.

Step 98 may include calculating a driver performance score based at least in part on the driver performance data received from the mobile device 10. Servers 22 may perform the calculations. In other embodiments, mobile device 10 running driver qualification application 44 may perform the driver performance score calculations.

Step 100 may include determining whether to provide the requested premium discount based on the calculated driver performance score. Servers 22 may perform this determination by comparing the calculated scores to a required minimum. In other embodiments, servers 22 may employ additional criteria, such as whether the driver has completed a driver qualification plan 70.

Step 102 may include communicating the determination to the user, the driver, an insurance company representative, and/or others. Servers 22 may generate one or more notifications and communicate them by phone, text message, internet, email, or through the driver qualification application 44. Driver qualification application 44 may provide a notification to the user through any user interface of mobile device 10.

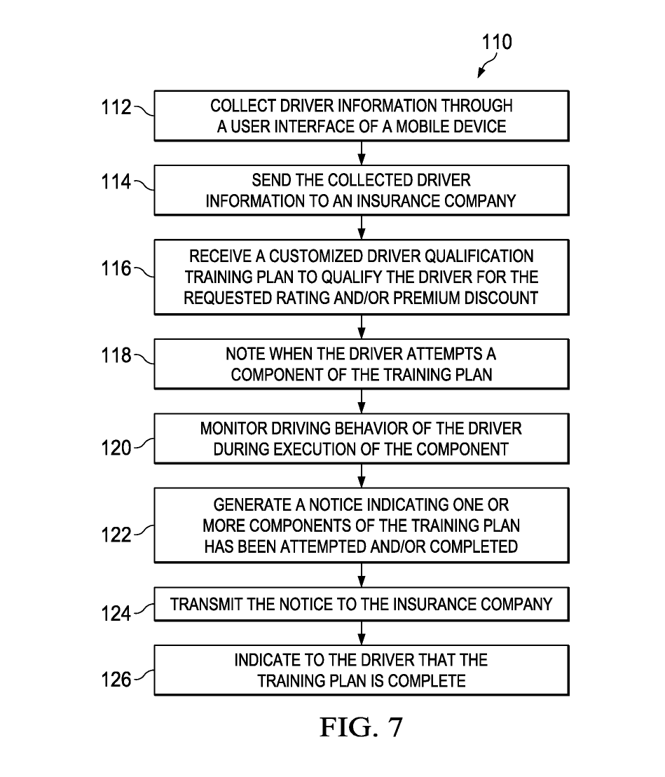

FIG. 7 is a flowchart illustrating an example method 110 which may be used by a driver or other user to request an insurance rating and/or an associated premium discount. Method 110 may be embodied in a driver qualification application 44 installed on the user's mobile device 10. In any step, mobile device 10 may be in communication with the insurance company servers 22 over the internet or another appropriate avenue.

Step 112 may include collecting driver information through a user interface of the mobile device 10.

Step 114 may include sending the collected driver information to insurance company servers 22.

Step 116 may include receiving a customized driver qualification training plan 70 to qualify the driver for the requested rating and/or premium discount.

Step 118 may include noting when the driver attempts a component of training plan 70. The component may include a training drive as described above.

Step 120 may include monitoring driving behavior of the driver during execution of the component of training plan 70.

Step 122 may include generating a notice indicating one or more components of training plan 70 has been attempted and/or completed.

Step 124 may include transmitting the notice to insurance company servers 22.

Step 126 may include indicating to the driver that customized driver qualification plan 70 is complete when all of the components have been completed satisfactorily.

In some embodiments, the methods and systems of the present disclosure may be used to improve the qualifications of a novice driver. In other embodiments, the methods may be used to recertify existing policy holders who previously qualified for an improved rating.

Under some insurance rating schemes, a driver may lose his or her qualifications by receiving a ticketed moving violation and/or being involved in an at-fault motor vehicle accident. The teachings of the present disclosure may be used to mitigate the lost qualification and/or allow the driver to regain a partial discount.

Some agencies and/or government entities that grant driver's licenses offer what may be referred to as “graduated driver licensing” or GDL. In general, a GDL scheme is designed to provide novice drivers driving experience and skills gradually over time to reduce the risk to the driver and others. In many GDL schemes, a novice driver may start with a permit that only allows accompanied drives, followed by a license with restrictions (e.g., no nighttime driving, no freeway driving, etc.). The teachings of the present disclosure may be used to verify and/or manage driver qualification programs which result in qualifying a novice driver for the next graduated step of a GDL scheme.

In many driver training schemes, a trainer or experienced driver must accompany a novice driver to monitor his or her performance and validate the amount of training. The teachings of the present disclosure may be used to monitor, track, and/or validate the training of a novice driver even if a trainer or experienced driver is not available. This may be useful, for example, in cases where a novice driver does not have an adult available for training (e.g., a single adult is the novice driver, no parent is available, etc.).

What is claimed:

1. A method for qualifying a driver for an insurance rating, the method comprising:
providing a driver qualification application to a driver for installation on a mobile device;
collecting driver data at an insurance company server, the data transmitted by the mobile device through the driver qualification application to the server;
the server comprising a processor and a memory that stores the driver data, wherein the server:
selects components of a driver qualification training plan to qualify the driver for one or more insurance ratings, the components selected at least in part based on the driver data;
generates a customized driver qualification training plan for the driver based on the selected components and storing the training plan at the server;
transmits the training plan to the mobile device through the driver qualification application;
receives notices from the driver qualification application indicating one or more components has been attempted or completed; and
when all components are complete, generates an alert over a wireless communication channel to the mobile device;
wherein the alert activates the driver qualification application to display a notification that the driver is qualified for the insurance rating.

2. A method according to claim 1, wherein the notification includes a discount based on the insurance rating for which the driver is qualified, the discount calculated by the server.

3. A method according to claim 1, wherein the server transmits the alert to an insurance company representative.

4. A method according to claim 1, wherein the driver data includes identification of an existing driver insurance policy.

5. A method according to claim 1, wherein the driver qualification training plan includes various required training drives.

6. A method according to claim 1, wherein the driver qualification training plan includes various required training drives to be completed with a trained driver as a passenger.

7. A method according to claim 1, wherein the driver qualification training plan includes various required training drives to be completed at certain times of day.

8. A method according to claim 1, wherein the driver qualification training plan includes various required training drives to be completed with no passengers in the automobile.

9. A method according to claim 1, wherein the driver qualification training plan includes various required training drives to be completed with a minimum performance score calculated by the server based at least in part on measurements of driving behavior by sensors associated with the mobile device while running the driver qualification application.

10. A method according to claim 1, wherein the driver qualification training plan corresponds to a licensing authority's requirements for a graduated driver's license.

11. A method according to claim 1, wherein:
the driver qualification application provides instructions for the mobile device to monitor the driver's driving behavior by collecting performance data reflecting the driving behavior of the driver and report the performance data to the insurance company server; and
the driver qualification training plan includes various required training drives to be completed by the driver while the driver qualification application monitors the driver's driving behavior.

12. A method according to claim 1, wherein:
the driver qualification application includes instructions for the mobile device to monitor the driver's driving behavior by collecting performance data reflecting the driving behavior of the driver and report the performance data to the insurance company server;
the insurance company server calculates a driver performance score based on the performance data; and
the driver qualification training plan includes various required training drives to be completed by the driver with a minimum driver performance score.

13. A method for offering vehicle insurance to a driver, the method comprising:
receiving a request sent over the internet from a mobile device initiated by a user for one or more vehicle insurance policies for a driver;
providing the user access to download an application to the mobile device over a wireless communication channel;
receiving driver information sent from the mobile device over the wireless communication channel triggered by the application to an insurance company server, the driver information collected by operation of the application and transmitted to the insurance company server by the mobile device, the server comprising a processor and a memory that stores the driver information;
receiving at the server driver performance data collected by sensors in communication with the mobile device during one or more trips made in a vehicle, the driver performance data reflecting driving behaviors of the driver during the one or more trips;
calculating, by the processor, a driver performance score based at least in part on the driver performance data transmitted by the mobile device; and
determining whether to qualify the driver for the one or more requested vehicle insurance policies based on the driver performance score.

14. A method according to claim 13, further comprising:
in response to a determine to qualify the driver for the one or more requested vehicle insurance policies, generating an alert over a wireless communication channel to the mobile device;
wherein the alert activates the driver qualification application to display a notification that the driver is qualified for the one or more requested vehicle insurance policies.

15. A non-transitory computer readable medium with computer executable instructions stored thereon executed by a processor to perform a method of qualifying for a premium discount, the method comprising:
collecting driver information associated with a driver through a mobile device interface;
sending the collected driver information to an insurance company server from the mobile device over the Internet;
receiving a customized driver qualification training plan to qualify the driver for one or more insurance ratings, particular components of the training plan determined by the insurance company server at least in part based on the driver information;
noting when the driver attempts a component of the training plan;
monitoring driving behavior of the driver during execution of the component of the training plan;
generating a notice indicating one or more components has been attempted or completed;
transmitting the notice to the insurance company server over the Internet; and
when all components are complete, indicating to the driver the customized driver qualification plan has been completed.

16. A non-transitory computer readable medium according to claim 15, wherein the method further comprises receiving an alert over a wireless communication channel from the insurance company server when all components are complete; and
in response to receiving the alert, displaying a notification that the driver is qualified for the insurance rating.
